(19) United States
(12) Patent Application Publication
(10) Pub. No.: US 2008/0114770 A1
(43) Pub. Date: May 15, 2008

(54) ATTRIBUTE LEVEL FEDERATION FROM MULTIPLE DATA SOURCES

(76) Inventors: JINFANG CHEN, AUSTIN, TX (US); DAVID G. ROBINSON, DURHAM, NC (US); SHAW-BEN SHEPHERD SHI, AUSTIN, TX (US); JONATHAN MARK WAGNER, ROUND ROCK, TX (US)

Correspondence Address: IBM CORP (YA);C/O YEE & ASSOCIATES PC, P.O. BOX 802333, DALLAS, TX, 75380, US

(21) Appl. No.: 11/559,600

(22) Filed: Nov. 14, 2006

(51) Int. Cl. G06F 17/30

(52) U.S. Cl. 707/10; 707/E17.005; 707/E17.032

(57) ABSTRACT

A computer implemented method, apparatus, and computer program product for retrieving data. The process identifies a class type for the requested attribute data to form an identified class type in response to receiving a request for attribute data for a configuration item from a client. The process generates a set of data windows associated with the identified class type. Each data window in the set of data windows provides availability information for attribute data available from a remote data source. The process attribute data associated with each data window in the set of data windows to form a set of attribute data. The process sends the set of attribute data to the client

### BACKGROUND

1. Technical Field

The present invention relates generally to an improved data processing system and in particular to a method and apparatus for a database manager. Still more particularly, the present invention relates to a computer implemented method, apparatus, and computer usable program code for providing attribute level federation from multiple data sources in a configuration management database.

2. Description of the Related Art

An information technology infrastructure library (ITIL) is a set of guidelines for information technology (IT) service management. ITIL consists of a series of publications giving guidance on the provision of quality IT Services, and on the processes and facilities needed to support them. ITIL guidelines are considered best practice guidelines for an IT service. Best practice is a technique, method, activity, or process that is considered more effective at providing a particular outcome than any other technique, method, activity, or process.

An IT service is a service provided to one or more customers by an IT service provider. An IT service is made up from a combination of people, processes and technology and should be defined in a service level agreement (SLA) based on the customer's use of IT. The IT service is then implemented to support the customer's business processes. IT service management (ITSM) is an implementation and management of IT services that meet the needs of a particular business. IT service management is performed by IT service providers through an appropriate mix of people, process and information technology.

Configuration management is the process responsible for maintaining information about configuration items required to deliver an IT service, including their relationships. The primary objective of configuration management is to underpin the delivery of IT services by providing accurate data to all IT service management processes when and where it is needed.

Configuration management manages information about configuration items throughout the lifecycle of a configuration item (CI). A CI is any component that needs to be managed in order to deliver an IT Service. CIs typically include hardware, software, buildings, people, and formal documentation such as process documentation and SLAs. Information about each CI is recorded in a configuration record within a configuration management database (CMDB). A configuration record is a record containing the details of a configuration item. Each configuration record documents the lifecycle of a single CI. Configuration records are stored in a CMDB.

A CMDB is a database used to manage configuration records throughout the lifecycle of the CI associated with the configuration record. The CMDB records the attributes of each CI, and relationships with other CIs. A CMDB may also contain other information linked to CIs, for example incident, problem or change records. The CMDB is maintained by configuration management and is used by all IT service management processes.

A CMDB generally stores only the key information of CIs. Clients, which connect to the configuration management database, often need to use CI data which is stored in separate data stores in addition to the data stored in the CMDB. To present a seamless view of CI data pulled from a local CMDB, as well as one or more remote data stores, the CMDB needs to provide a federation feature.

A federation feature enables clients to request configuration item data from multiple data sources using CMDB application programming interfaces (APIs) without the need to know the actual location of the data. The federation feature searches multiple geographically and technologically disparate computer systems to locate and transform related data from the multiple separate data sources. The CMDB transparently combines the data from the multiple data sources and returns the combined data to the client.

However, there are several difficulties to presenting seamless data for clients of the CMDB. First, data for a single CI may reside in two or more federated data sources. In addition, the federated data sources may provide attributes for two or more CIs. A CMDB may have difficulty retrieving information from two or more data sources due to differences in data source types, data store access mechanism, and data schema. A CMDB may also have difficulty knowing which configuration items and attributes are stored in each data source.

Finally, two or more federated data sources may provide data for the same attribute for a CI. In such a case, the CMDB may have difficulty combining the attribute data due to determining which instance of the attribute data should be given preeminence. In other words, the system may be unable to determine which data source to rely upon for the given attribute data. This can be a significant problem where the data for the given attribute provided by each data source differs in any respect.

### BRIEF SUMMARY

The illustrative embodiments described herein provide a computer implemented method, apparatus, and computer program product for retrieving data. In one embodiment, the process identifies a class type for the requested attribute data to form an identified class type in response to receiving a request for attribute data for a configuration item from a client. The process generates a set of data windows associated with the identified class type. Each data window in the set of data windows provides availability information for attribute data available of a specific configuration item from a remote data source. The process retrieves attribute data associated with each data window in the set of data windows to form a set of attribute data. The process sends the set of attribute data to the client.

### BRIEF DESCRIPTION OF THE DRAWINGS

The novel features believed characteristic of the illustrative embodiments are set forth in the appended claims. The illustrative embodiments, themselves, as well as a preferred mode of use, further objectives, and advantages thereof, will best be understood by reference to the following detailed description of an illustrative embodiment when read in conjunction with the accompanying drawings, wherein:

FIG. 1 is a pictorial representation of a network of data processing systems in which illustrative embodiments of the present invention may be implemented;

FIG. 2 is a block diagram of a data processing system in which illustrative embodiments of the present invention may be implemented;

FIG. 3 is a diagram illustrating a configuration management database in accordance with an illustrative embodiment of the present invention;

FIG. 4 is a diagram illustrating a data flow between a client and server for a configuration management database search query in accordance with an illustrative embodiment of the present invention;

FIG. 5 is a flowchart of a process for plug-in installation in accordance with an illustrative embodiment of the present invention;

FIG. 6 is a flowchart of a process for a server start-up in accordance with an illustrative embodiment of the present invention;

FIG. 7 is a flowchart of a process for a client start-up in accordance with an illustrative embodiment of the present invention; and

FIG. 8 is a flowchart of a process for a server responding to a client request for configuration item data in accordance with an illustrative embodiment of the present invention.

### DETAILED DESCRIPTION OF AN ILLUSTRATIVE EMBODIMENT

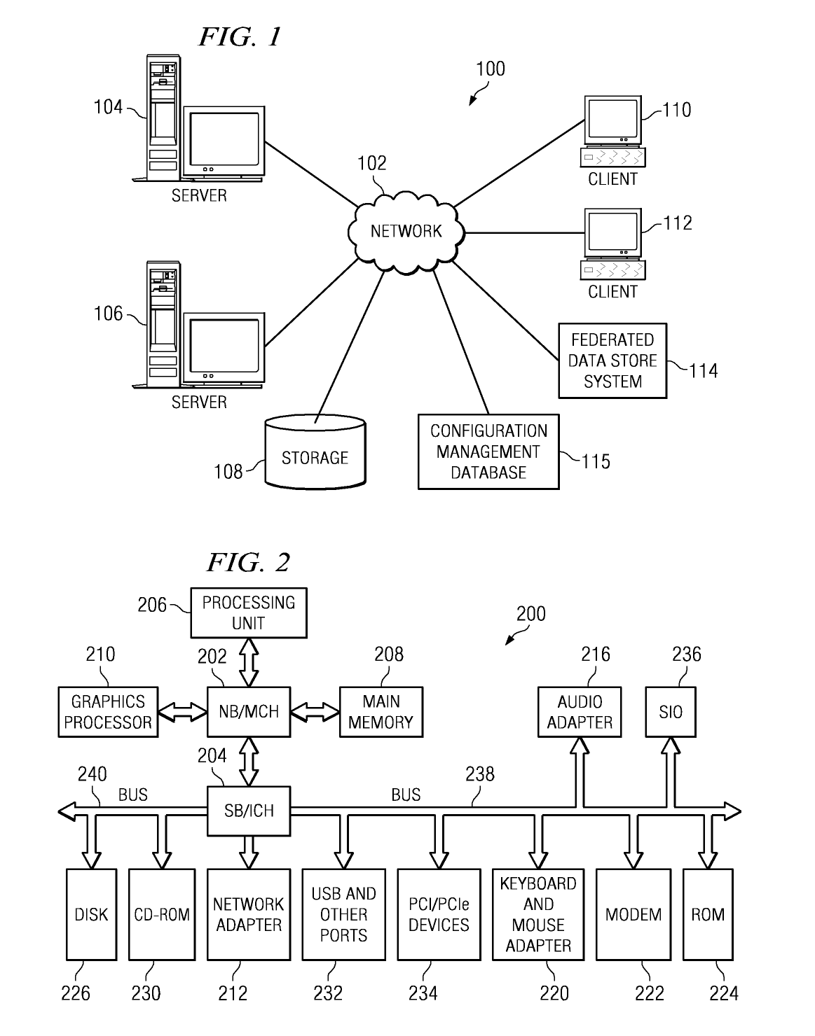

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110 and 112 connect to network 102. These clients 110 and 112 may be, for example, personal computers or network computers. In the depicted example, server 104 provides data, such as boot files, operating system images, and applications to clients 110 and 112. Clients 110 and 112 are clients to server 104 in this example.

Federated data store system 114 and configuration management database 115 are also connected to network 102. Federated data store system 114 is a data management system that transparently integrates multiple autonomous data stores into a single federated data store. The multiple autonomous data stores can be geographically remote and/or technologically disparate data storage systems, including but not limited to, a database, a filesystem, or any other type of data store.

These autonomous data stores are interconnected via network 102. A user can search for data on one or more of the remote data stores on federated data store system 114 by means of a single federated data query. In other words, the federated data store system 114 provides a virtual data composite of all constituent databases, file systems or other data stores in federated data store system 114.

Configuration management database 115 is a database system that stores and organizes configuration data for a data processing system, such as data processing system 100. Configuration management database 115 accesses federated data store system 114 via network 102. Network data processing system 100 may include additional servers, clients, databases, data storage, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200. Java and all Java-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments of the present invention provide a computer implemented method, apparatus, and computer program product for retrieving data. In one embodiment, the process identifies a class type for the requested attribute data to form an identified class type in response to receiving a request for attribute data for a configuration item from a client. The process generates a set of data windows associated with the identified class type. Each data window in the set of data windows provides availability information for attribute data available from a remote data source. The process retrieves attribute data of the requested class type from each data window in the set of data windows to form a set of attribute data. The process sends the set of attribute data to the client.

The process checks a data window map to identify each data window associated with the class type and attribute types specified in the request, if any, to generate the set of data windows associated with the requested class type. A data window map is a map providing availability information for class type and attribute data in multiple data windows associated with a single data source, such as a federated data source or configuration management database.

In this illustrative embodiment, a data window is a meta data structure generated by a plug-in. Each data window provides a fixed set of attributes for a specific classtype. One remote data source can have multiple data windows offering different views into the remote data. A data window provides information for connecting to a remote data source having attribute data for the class type and describes the attribute data available from the remote data source.

The process retrieves attribute data associated with each data window in the set of data windows to form a set of attribute data. The process retrieves attribute data values associated with the class type and a specified attribute of the class type. A specified attribute is an attribute of a class type specified in the request from the client.

Attribute data may be retrieved from two or more data sources. The data sources may be local data sources or remote (federated) data sources. The attribute data from the multiple different data sources are integrated into a single set of attribute data.

If attribute values for the same attribute are retrieved from different data sources, the process retrieves a policy that specifies a rank for each data window. The policy can be a user defined policy or a predefined default policy. The process selects an attribute data value from a data window having a highest rank and discards an attribute data value from a data window having a lowest rank based on the policy. The set of attribute data is then sent to the client.

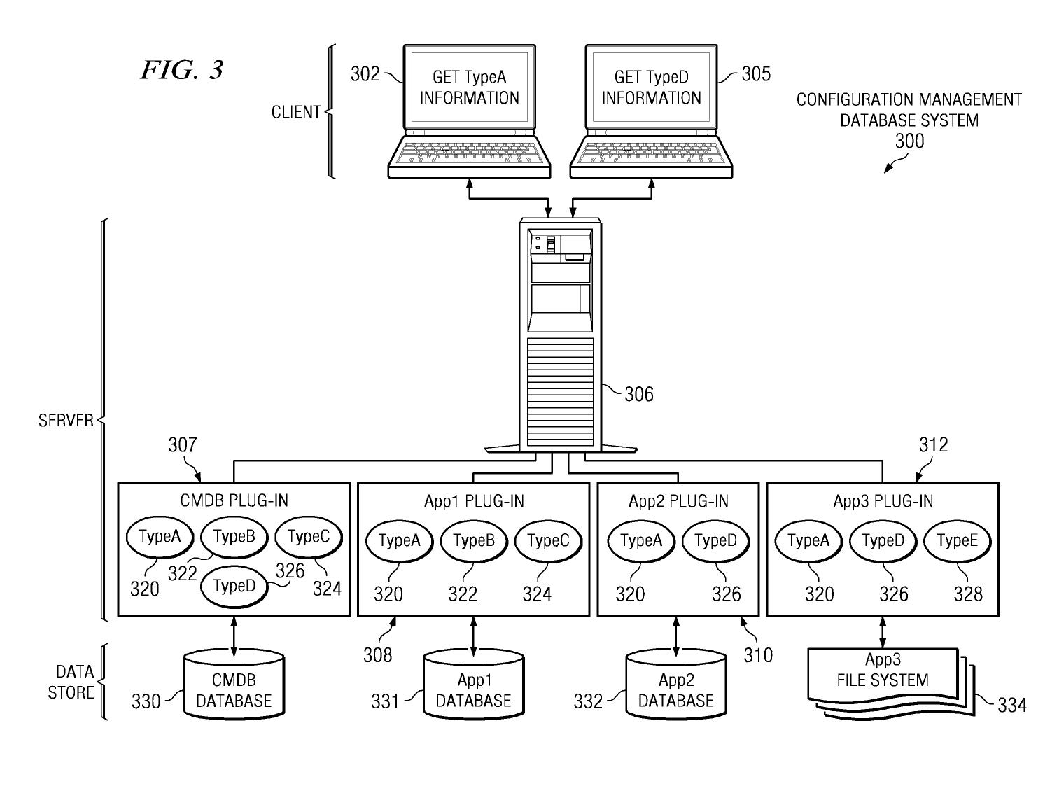

Turning now to FIG. 3, a diagram illustrating a configuration management database is shown in accordance with an illustrative embodiment of the present invention. Configuration management database 300 is a system including a configuration management database, such as configuration management database 115 in FIG. 1.

Client 302 and client 305 are any known or available client computing devices, including but not limited to, a desktop computer, a laptop computer, a personal digital assistant (PDA), a notebook computer, a cell phone, a smart watch, and/or any other device to enable a user to access a network. In this illustrative example, client 302 and client 305 are client computer such as client 110-112 in FIG. 1.

Server 306 is any type of server, such as server 104 and 106 in FIG. 1. Server 306 is a server on a network, such as network 102 described in FIG. 1.

Configuration management database (CMDB) plug-in 307 and federation plug-ins 308, 310, and 312 are plug-ins installed on server 306. A plug-in is a computer program that interacts with a main application to provide a given function. A main application is any application on server 306, such as a web browser, email program, or database manager. In this illustrative example, federation plug-ins 308-312 are plug-ins providing a function for sub-classing data sources from remote (federated) data sources into class-type data windows. A data-class type window provides information regarding the type, kind, or classification of configuration item data stored in a corresponding data store. In this illustrative example, each data window provides a fixed set of attributes for a single class type.

Federation plug-ins 308-312 define the context of configuration data in remote data sources as class types. A class type is used to group related variables and functions of an object. A class describes a collection of encapsulated instance variables and methods or functions. In this example, client 302 is requesting configuration data for a type-class “A”. Client 305 is requesting configuration data for a type-class “D.”

A federated data source is a remote data sources on a federated data store system, such as federated data store system 114 in FIG. 1. A federated data source is an autonomous database that may be geographically remote to server 306 and/or different database schema. A database schema is a structural description of the type of facts held in the database. Data in a database can be structured according to a variety of schemas, including but not limited to, a relational model, a hierarchical model, a network model, a flat model, or any other known or available schema.

Each plug-in on the server contains information on how to locate and connect to a remote federated data source. For example, the plug-in may contain an Internet protocol (IP) address or media access control (MAC) address. The plug-in also describes attribute data available from the data source associated with that plug-in as a class-type. In other words, data objects available from a federated data source are classified according to the type, kind, class, or group of data. The class-type of data available from a data source is provided to a user in a class-type data window generated by the plug-in.

Plug-ins 307-312 sub-classify the data objects stored on configuration management database 330 and one or more federated data stores 331-334 into class-type data windows, such as data windows. The plug-in generates the class-type data window, which includes a list of class types of data objects associated with the given federated data source, based on information obtained from the federated data source by the plug-in. The plug-in accesses a federated data source by means of a network connection, such as network 102 in FIG. 2.

As used herein, a class-type is a class or group for a particular attribute or a set of attributes. For example, a class-type can represent an attribute or a set of attributes related to a configuration item, such as a hardware input/output device or a software application configuration item. In this example, class-type “A” 320, class-type “B” 322, class-type “C” 324, class-type “D” 326, and class-type “E” 328 are class-types for classifying attribute data. Plug-in 308 includes class-type “A” 320, class-type “B” 322, and class-type “C” 324. Plug-in 310 includes class-type “A” 320 and class-type “D” 326. Plug-in 312 includes class-type “A” 320, class-type “D” 322, and class-type “E” 328.

Server 306 uses a data store, such as data stores 330-334, to store plug-in information once a plug-in is installed. Each class-type data window generated by a given plug-in has a corresponding data store. The data store contains configuration item specific data for each class-type in the data window. The data store can be a database, such as configuration management database 330, database 331 and 332, a file system, such as data store 334, or any other known or available storage mechanism. In this illustrative example, data store 330 is a data store for plug-in data window 308, data store 332 is a data store for plug-in data window 310, and data store 334 is a data store for plug-in data window 312.

Plug-ins 308-312 provide information for locating and connecting to federated data sources. Server 306 will extract class-type data “A” 320 from the federated data source using information in plug-ins 308-312.

In this illustrative example, the client request is a request for only a single class type of configuration data. However, in accordance with the illustrative embodiments, a client request can specify more than one class type on one client to server call.

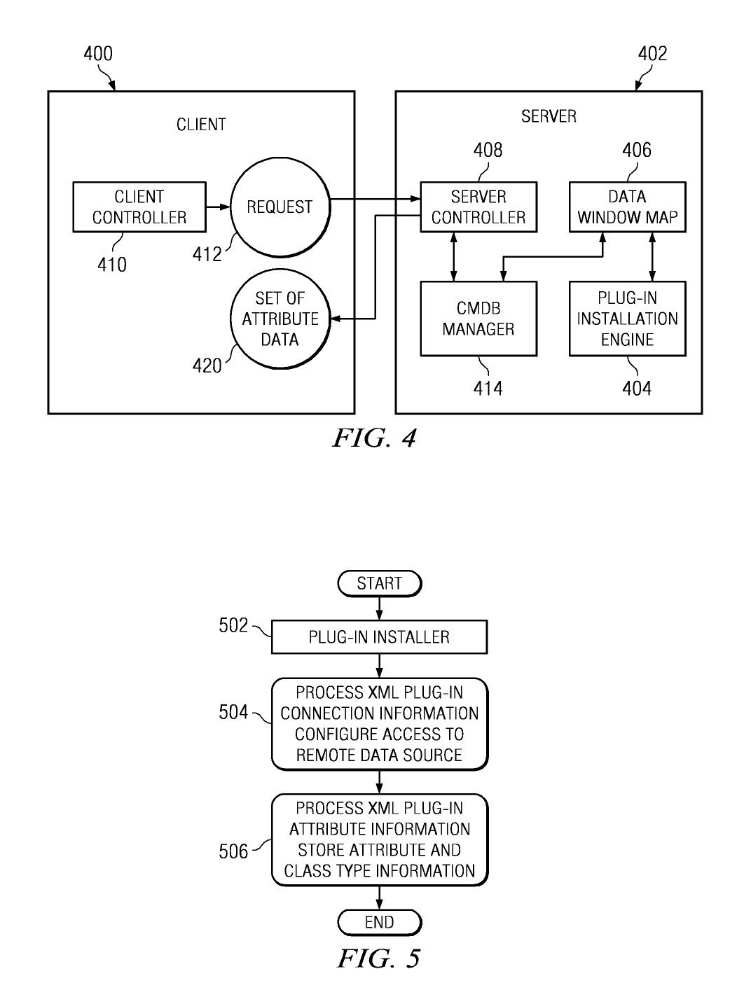

FIG. 4 is a diagram illustrating a data flow between a client and server for a configuration management database search query in accordance with an illustrative embodiment of the present invention. Client 400 is any known or available client computing device, including but not limited to, a desktop computer, a laptop computer, and/or any other device to enable a user to access a network. In this illustrative example, client 400 is a client such as client 302 in FIG. 3 or client 110 and 112 in FIG. 1.

Server 402 is any type of server, such as server 104 and 106 in FIG. 1. Server 402 can be a server on a network, such as network 102 described in FIG. 1. Client 400 accesses server 402 through a network, such as network 102 in FIG. 1. In this example, server 402 is a configuration management database server.

At install time, plug-in installation engine 404 is a software component for installing one or more federation plug-ins, such as plug-ins 308-312 in FIG. 3. At install time, plug-in installation engine 404 on server 402 processes federation plug-ins to build data window map 406. In this illustrative example, an extensible markup language (XML) file is used by plug-in installation engine 404 to process federation plug-ins. However, in accordance with the illustrative embodiments, federated plug-ins can be processed using any type of file type which stores plug-in information.

A plug-in has two distinct sections. One section describes how to locate and connect to a federated data source. The location and connection information is used by the plug-in to retrieve or extract attribute data from the federated data source. The second section describes the attribute data available from that plug-in from the federated data source.

Server 402 configures connections to the remote data source as necessary in accordance with the information provided by the plug-in. The plug-in records detailed information with respect to attribute availability from the plug-in in a relational database. Plug-in installation engine 404 completes installation of the plug-ins. After plug-in installation at installation time, server 402 is rebooted. After reboot, attribute data generated by the plug-ins becomes available to server 402 for use in generating a set of data windows and data window map 406. As used herein, a set of data window includes one or more data windows.

Plug-in installation engine 404 generates data windows and data window map 406. At server start time, which occurs after the plug-in installation, the data windows and data window map associated to the new installed plug-in become available to the server. Data window map 406 is a map that identifies which data store has which configuration item data. As used herein, a data window map is a map detailing all the class-types and attribute types for every data window on a given server. Referring back to FIG. 3, a data map for server 302 would include the following information:

```
app1 data window map
  TypeA data window, “attr1, attr2”
  TypeB data window, “attr3”
  TypeC data window, “attr1, attr2, attr4”
app2 data window map
  TypeA, “attr1, attr3”
  TypeD, “attr1, attr2, attr3, attr5”
app3 data window map,
  TypeA, “attr2, attr4”
  TypeD, “attr6”
  TypeE. “attr1, attr2, attr5”
```

Thus, data window maps 406 is a map of all class-types of objects and all attribute types available in every data window on server 402.

Each class-type data window is associated with a single attribute data class type. Each data window map is associated with a single federated data source. In other words, a data window map includes information regarding the availability of attribute data for one or more attribute data class types that are available on a single data store. A given data window includes information regarding the availability of attribute data for a single federated data source and a single attribute data class type. However, a single federated data source may have multiple class-type data windows and multiple data window maps associated with the federated data source. Multiple data windows may be desired because different data windows can offer different views into the remote data source.

Server controller 408 is a software component for receiving a request, such as request 412, from a client. Server controller 408 also responds to client requests by generating and sending a set of attribute data responsive to the client request back to the client.

Request 412 is a request for configuration data relating to a particular configuration item. Request 412 includes a class-type. Request may also optionally include specific attributes from the class-type to further refine the request.

Configuration management database (CMDB) 414 is a software component for loading class type data window maps and checking data window map 406 for requested configuration item data. Client controller 410 is a software component for recognizing a server, obtaining configuration data for connecting to the server, and generating configuration data requests, such as request 412.

Thus, at run-time, client 400 sends request 412 to server controller 408 on server 402 by means of client controller 410. Request 412 is a configuration data request to a configuration management database server for a single attribute data object or a complete set of two or more attribute data objects for a given configuration item. Server controller 408 receives the configuration data request.

Configuration management database (CMDB) manager 414 is a software component for managing and querying a configuration management database and/or one or more federated data stores for class-type data responsive to user requests. CMDB manager 414 searches the relational database to find data windows providing attributes for the requested class type. CMDB manager 414 builds a first list of these data windows. The first list is a list of selected data windows having a class-type requested by client 400.

If the request from client 400 also provided specific attributes from the class type requested by the user, CMBD manager 414 further refines the selected list by determining which data windows provide the requested attributes for the requested class-type. Any data windows for the requested class-type that do not also include a requested attribute are removed from the list. This refined list is a second or modified list of selected data windows. Generating the modified list of selected data windows improves performance and reduces the number of remote data source calls when retrieving the requested attribute data because only data windows having both a requested class-type and a requested attribute type are retrieved rather than retrieving all data windows for the requested class-type.

Once the selected list of applicable data windows is built, the server requests the attributes from each data window in the list of selected data windows. CMDB manager 414 integrates the attribute data retrieved from the different remote data sources, as well as any attribute data retrieved from the local configuration management database itself.

Server controller 408 returns the integrated set of attribute data 420 to client 400 in a seamless fashion. Thus, client 400 requests and receives configuration data from a single interface with server 402 despite the fact that the returned configuration data may have been retrieved from multiple remote data sources to form set of attribute data 420. Set of attribute data 420 is the set of attribute data that is responsive to client request 412.

If CMDB manager 414 retrieves data for the same given attribute from two or more data sources, CMDB manager 414 retrieves a policy that defines the rank of each data window. The data value for the given attribute from a data window having the highest rank in accordance with the policy is utilized in the integrated set of attribute data 420 that is returned to client 400.

If no policy exists for resolving the conflict between the two instances of attribute values for the same given attribute, CMDB manager 414 includes both instances of the different attribute values in set of attribute data 420 returned to client 400. However, CMDB manager 414 prefixes each instance of a value for the same attribute with a prefix indicating the particular data source from which that attribute value was retrieved. In this manner, a user can identify the source of each attribute value.

In this example, a plug-in only has two sections. However, in accordance with the illustrative embodiments of the present invention, plug-ins can have any number of sections describing additional information for accessing, describing, and locating data on a remote data source.

Referring now to FIG. 5, a flowchart of a process for plug-in installation is depicted in accordance with an illustrative embodiment of the present invention. In this illustrative example of the present invention in FIG. 5, the process is implemented by plug-in installation engine 404 in FIG. 4.

The process begins by installing a plug-in (process block 502). The process installs a plug-in by loading an extensible markup language (XML) file with data store information relating to a particular remote data source. The XML file contains XML plug-in information to configure a connection to the remote data source. The XML file also contains attribute information for attributes stored in the remote data source.

The process obtains plug-in connection information to configure access to the remote data source by processing the XML file (process block 504). The XML file is further processed to obtain the plug-in attribute information and to store class-type and attribute information in a data window map for the remote data source (process block 506) with the process terminating thereafter. In this example, the file processed to install a plug-in is an XML file. However, in accordance with another illustrative example, the file can be a file written in any known or available programming language.

After this process for loading a plug-in is complete, the configuration management database server is restarted or rebooted to load a data window map and attribute types.

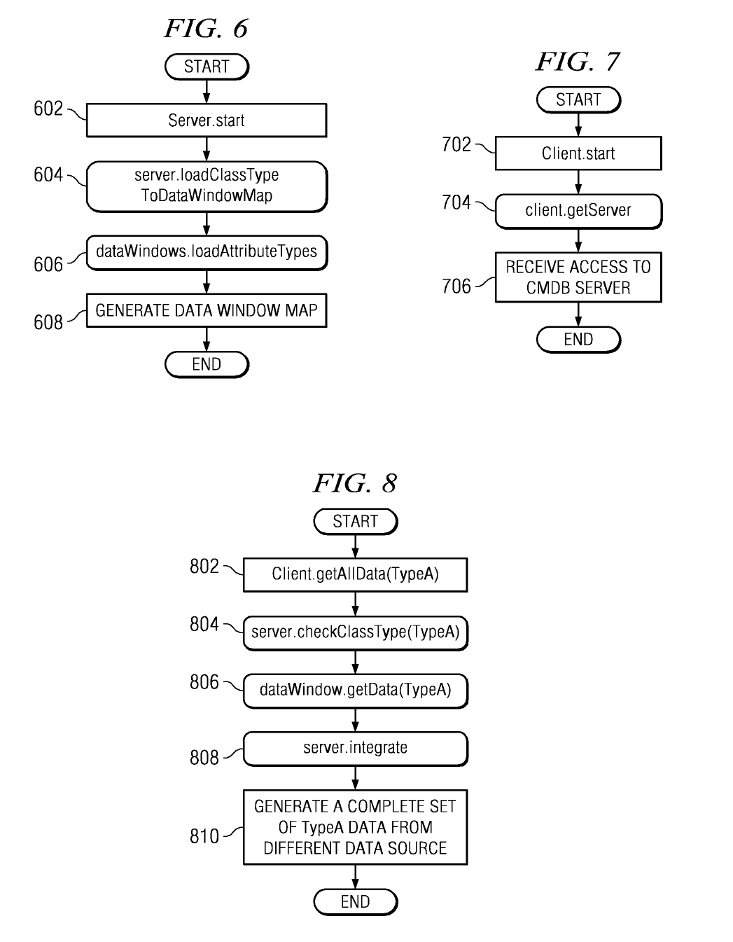

FIG. 6 is a flowchart of a process for a server start-up in accordance with an illustrative embodiment of the present invention. The process is performed by a software component for controlling a server restart or reboot process to load data window maps. In this illustrative example of the present invention in FIG. 6, the process is implemented by server controller 408 in FIG. 4.

The process begins by starting or rebooting a configuration management database server (process block 602). The process loads all class types that have data windows providing federated attributes to a data window map (process block 604). The process loads attribute types into the data window map (process block 606). For each data window object, all supported attribute types are loaded. Attribute values are classified into attribute types. An attribute type indicates a set of attribute values that have the same generic meaning or intended purpose. For example, a central processing unit is an attribute type of a computer system class type.

Finally, the process generates a data window map (process block 608) with the process terminating thereafter. The data window map is a list of all class-types for a given data window. The data window map contains information regarding configuration items and attribute objects.

Turning now to FIG. 7, a flowchart of a process for a client start-up is shown in accordance with an illustrative embodiment of the present invention. The process is performed by a software component for starting or booting a client. In this illustrative example of the present invention in FIG. 7, the process is implemented by client controller 410 in FIG. 4.

The process begins by starting a client boot process (process block 702). Next, the client recognizes the server and locates configuration data to access the server (process block 704). Configuration information includes security information, server internet protocol (IP) address, and any other information for establishing a connection with a server. The process is granted access to the configuration management database server (process block 706) with the process terminating thereafter. Once a connection is established and access is granted, the client can request configuration data from configuration management database server for a configuration item of any class-type, such as class-type “A” in 302 of FIG. 3.

FIG. 8 is a flowchart of a process for a server responding to a client request for configuration item data in accordance with an illustrative embodiment of the present invention. The process is performed by a software component for providing configuration data responsive to a client request. In this illustrative example in FIG. 8, the process is implemented by configuration management database manager 414 in FIG. 4.

The process begins by receiving a request to get all data for a configuration item of a particular class-type, such as type “A” from a client (process block 802). The request may also specify particular attributes of the class type. For example, the request in this example specifies all data for class-type “A” and attributes 1, 2, and 3.

The process checks a data window map to determine which data windows have data for the requested class-type (process block 804). In this example, the process checks the data window map to locate all data windows having data for class-type “A.” The data windows identified as including the requested class-type are added to a list of selected data windows.

The process then gets the attribute data from each data window on the list of selected data windows (process block 806). In this example, the client also specified attribute types 1, 2, and 3. In such a case, the process will only get attribute data from each data window that is of the specified attribute type. In this example, the process will only get attribute data of type 1, 2, and 3 from the data windows on the list of selected data windows. In other words, the process filters out data attributes that are not specified attributes. However, if the client did not specify attribute types, the process would have retrieved all attribute data from the data windows in the list of selected data windows.

Next, the process integrates the retrieved attribute data into an integrated set of attribute data (process block 808). During this step, if different attribute values are retrieved from different data windows for the same attribute, the process will use a policy to determine a rank for each data window. The process will use the attribute value from the attribute window with the highest rank. The attribute value from the lower ranked data window is discarded. The policy is a user defined policy. Thus, a user can define the resolution policy by which data attributes are filtered from the data attribute response set provided to a client. In another embodiment, the policy is a predefined default policy specifying resolution of conflicting or overlapping attribute values.

In the alternative, the process provides both attribute values in the integrated set of attribute values. However, the process appends a pre-fix identifying the source of each of the attribute values. In this manner, a user can determine the source of the conflicting or differing attribute values. In this manner, the process can return multiple sources of attribute values for a given attribute. Thus, the process can implement a policy to return one value in the case of multiple attribute values or return more than one source of attribute values to the client.

Finally, the process generates the complete set of attribute data for the requested class-type from the multiple different data source (process block 810) and provides this list to the client with the process terminating thereafter.

Thus, the illustrative embodiments of the present invention provide a computer implemented method, apparatus, and computer program product for managing a database. The process identifies a class type for the requested attribute data in response to receiving a request for attribute data for a configuration item from a client. A list of data windows associated with the class type is generated. A data window provides information for connecting to a remote data source having attribute data for the class type and describes the attribute data available from the remote data source. The process retrieves attribute data associated with each data window in the list of data windows to form a set of attribute data. The set of attribute data is then sent to the client.

The illustrative embodiments of the present invention permit managing attribute data from multiple remote data sources at the object class level. A method for sub-classing data sources into class-type data windows, characterizing attribute data in each class-type data window, and providing naming rules and policy control for attribute level data is provided. In this manner, data federation becomes a transparent activity to clients. A flexible configuration of federation data is enabled. The class-typing allows for focused attribute federation, simplifies data retrieval and increases the speed of data retrieval from federated data sources. Finally, conflicts between remote data sources are avoided and/or resolved transparently in accordance with policy rules provided by the illustrative embodiments.

In addition, the process uses XML packages to contain connectivity information, class level and attribute level descriptions that simplify and automate the process required to set up a data window. This enables the configuration management database server to be the single access point to connect to different data sources. This is an extension and refinement of the plug-in concept to solve problems of accessing and retrieving configuration data from federated data store systems by providing data based on a class view rather than a database view. Finally, federated attributes can be dynamically added through the plug-ins without having to compensate for database schema changes.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Embodiments of the present invention may be implemented entirely in hardware, entirely in software or using a combination of both hardware and software elements. In one embodiment, the invention is implemented in software, including but not being limited to firmware, resident software, microcode, or the like.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a communication medium (e.g., a system bus). The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention embodiments in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for retrieving data, the computer implemented method comprising:
responsive to receiving a request for attribute data for a configuration item from a client, identifying a class type for the requested attribute data to form an identified class type;
generating a set of data windows associated with the identified class type, and wherein each data window in the set of data windows provides availability information for attribute data available from a remote data source;
retrieving attribute data associated with each data window in the set of data windows to form a set of attribute data; and
sending the set of attribute data to the client

2. The computer implemented method of claim 1 wherein the step of retrieving attribute data further comprises:
retrieving attribute data from a plurality of remote data sources based on the availability information; and
integrating the attribute data from the plurality of data sources into a single set of attribute data.

3. The computer implemented method of claim 2 further comprising:
responsive to identifying overlapping attribute data values associated with two different data windows, retrieving a policy that specifies a rank for each data window; and
selecting an attribute data value from a data window having a highest rank and discarding an attribute data value from a data window having a lowest rank based on the policy.

4. The computer implemented method of claim 1 wherein generating a list of data windows further comprises:
identifying a set of specified attributes in the request from the client; and
selecting data windows associated with the class type and the set of specified attributes to form the list of data windows.

5. The computer implemented method of claim 1 wherein retrieving attribute data further comprises:
retrieving attribute data values associated with the identified class type and a specified attribute, wherein a specified attribute is an attribute of a class type specified in the request from the client.

6. The computer implemented method of claim 1 further comprising:
processing an extensible markup language file to load a plug-in at a server, wherein the plug-in generates a data window associated with a remote data source.

7. The computer implemented method of claim 1 further comprising:
generating a data window map, wherein the data window map provides information regarding a configuration item and attribute objects associated with every data window in a plurality of data windows.

8. The computer implemented method of claim 7 further comprising:
identifying each data window associated with the class type and an attribute type specified in the request to form the list of data windows, wherein each data window associated with the class type and the attribute type specified in the request is identified by checking the data window map.

9. A data processing system comprising:
a bus system;
a communications system connected to the bus system;
a memory connected to the bus system, wherein the memory comprises computer usable program code; and a processing unit connected to the bus system, wherein the processing unit executes the computer usable program code to identify a class type for the requested attribute data to form an identified class type in response to receiving a request for attribute data for a configuration item from a client; generate a set of data windows associated with the identified class type, and wherein each data window in the set of data windows provides availability information for attribute data available from a remote data source; retrieve attribute data associated with each data window in the set of data windows to form a set of attribute data; and send the set of attribute data to the client.

10. The data processing system of claim 9 wherein the processor unit further executes the computer usable program code to retrieve attribute data from a plurality of remote data sources based on the availability information; and integrate the attribute data from the plurality of data sources into a single set of attribute data.

11. The data processing system of claim 9 wherein the processor unit further executes the computer usable program code to retrieve a policy that specifies a rank for each data window in response to identifying overlapping attribute data values associated with two different data windows; and select an attribute data value from a data window having a highest rank and discard an attribute data value from a data window having a lowest rank based on the policy.

12. The data processing system of claim 9 wherein the processor unit further executes the computer usable program code to generate a data window map, wherein the data window map provides information regarding a configuration item and attribute objects associated with every data window in a plurality of data windows

13. A computer program product comprising:
a computer usable medium including computer usable program code for retrieving data, said computer program product comprising:
computer usable program code for identifying a class type for the requested attribute data to form an identified class type in response to receiving a request for attribute data for a configuration item from a client;
computer usable program code for generating a set of data windows associated with the identified class type, and wherein each data window in the set of data windows provides availability information for attribute data available from a remote data source;
computer usable program code for retrieving attribute data associated with each data window in the set of data windows to form a set of attribute data; and
computer usable program code for sending the set of attribute data to the client.

14. The computer program product of claim 13 further comprising:
computer usable program code for retrieving attribute data from a plurality of data sources based on the availability information; and
computer usable program code for integrating the attribute data from the plurality of data sources into a single set of attribute data.

15. The computer program product of claim 14 further comprising:
computer usable program code for retrieving a policy that specifies a rank for each data window in response to identifying overlapping attribute data values associated with two different data windows; and
computer usable program code for selecting an attribute data value from a data window having a highest rank and discarding an attribute data value from a data window having a lowest rank based on the policy.

16. The computer program product of claim 13 further comprising:
computer usable program code for identifying a set of specified attributes in the request from the client; and
computer usable program code for selecting data windows associated with the class type and the set of specified attributes to form the list of data windows.

17. The computer program product of claim 13 further comprising:
computer usable program code for retrieving attribute data values associated with the identified class type and a specified attribute, wherein a specified attribute is an attribute of a class type specified in the request from the client.

18. The computer program product of claim 13 further comprising:
computer usable program code for processing an extensible markup language file to load a plug-in at a server, wherein the plug-in generates a data window associated with a remote data source.

19. The computer program product of claim 13 further comprising:
computer usable program code for generating a data window map, wherein the data window map provides information regarding a configuration item and attribute objects associated with every data window in a plurality of data windows.

20. A system for retrieving data, the system comprising:
a server controller for receiving a request for attribute data for a configuration item from a client to form requested attribute data, wherein the request identifies a class type for the requested attribute data to form an identified class type;
a plug-in installation engine, wherein the plug-in installation engine generates a set of data windows associated with the identified class type, and wherein each data window in the set of data windows provides availability information for attribute data available from a remote data source; and
a configuration management database manager, wherein the configuration management database manager retrieves attribute data associated with a remote data source having attribute data for the class type; and wherein the server controller sends the set of attribute data to the client.
